(19) United States
(12) Patent Application Publication
(10) Pub. No.: US 2008/0166088 A1
(43) Pub. Date: Jul. 10, 2008

(54) Optical fiber module, method for manufacturing of optical fiber module, and closure thereof

(76) Inventor: Shinjiro Hagihara, Yokohama (JP)

Correspondence Address: MCDERMOTT WILL & EMERY LLP, 600 13TH STREET, N.W., WASHINGTON, DC, 20005-3096, US

(21) Appl. No.: 12/007,054

(22) Filed: Jan. 4, 2008

(30) Foreign Application Priority Data
Jan. 4, 2007 (JP) P.2007-000095

(51) Int. Cl. G02B 6/26

(52) U.S. Cl. 385/27

(57) ABSTRACT

A dispersion compensating fiber module having a dispersion compensating function has a fiber arranging portion including a plurality of fiber housing portions (housing) which are concentrically disposed and accommodate a dispersion compensating fiber, and a fiber connecting portion connecting the dispersion compensating fibers accommodated in three fiber housing portions.

The application is based on Japanese Patent Application (JP-A-2007-000095) filed on Jan. 4, 2007, the contents of which are hereby incorporated by reference.

### BACKGROUND ART

1. Field of the Invention

The present invention relates to an optical fiber module having a dispersing and compensating function, a method of manufacturing an optical fiber module, and a closure having an optical fiber module.

2. Related Art

Referring to a wavelength which can be used in an optical fiber communication, conventionally, there have been known a 0.85 μm band of a short wavelength and a 1.3 μm band and a 1.55 μm band of long wavelengths. However, a characteristic for an optical fiber is more excellent in a long wavelength band in respect of a transmission loss or a dispersing characteristic for determining a relay interval. As the wavelength for the optical fiber communication, therefore, the 1.3 μm band and the 1.55 μm band are used as a mainstream.

Referring to a light in the long wavelength band, for example, the 1.3 μm band which does not need to consider the influence of a dispersion is mainly used for a short distance system (for an intra-office connection) and the 1.55 μm band is mainly used for a long distance transmission (an interoffice connection). When a single mode fiber (a 1.3 SMF) which has a zero-dispersion wavelength (a wavelength which can cancel a dispersion such as a material dispersion or a structure dispersion) in the 1.3 μm band is carried out an optical transmission in the 1.55 μm band, for example, the zero-dispersion wavelengths are not coincident with the 1.55 μm band. For this reason, a great wavelength dispersion is generated so that a light signal is distorted and signal quality is deteriorated. Therefore, when the 1.3 SMF is carried out the optical transmission in the 1.55 μm band, for example, it is necessary to provide means for suppressing the wavelength dispersion. As one of them, there has been known a dispersion compensating fiber (DCF) having a great wavelength dispersion in a reverse sign to the 1.55 SMF.

In recent years, the optical fiber transmission has been spread into home (FTTH: Fiber To The Home). In a transmission to be carried out through an optical fiber, a necessity for compensating for a dispersion generated in an optical transmission path is increased. Therefore, there has been variously investigated and proposed a development of a dispersion compensating fiber module (DCFM) obtained by changing the dispersion compensating fiber (DCF) into a module.

Some specific examples of the dispersion compensating fiber module will be described below with reference to the drawings. A dispersion compensating fiber module shown in FIG. 7 has a structure in which a plurality of dispersion compensating fiber coils is provided in a module and is switched and connected so that a quantity of a wavelength dispersion can easily be adjusted (for example, see JP-A-2004-198821). More specifically, as shown in FIG. 7, a dispersion compensating fiber module 101 has a module housing 102 and a plurality of optical fiber coil portions 103 is disposed in the module housing 102. Each of the optical fiber coil portions 103 is formed by winding a dispersion compensating fiber 105 around a plurality of bobbins 104 respectively. On the other hand, a single mode optical fiber 106 is fusion spliced to both ends of the dispersion compensating fiber 105 through a fusing portion 107, respectively. In other words, one of the ends of the dispersion compensating fiber 105 in the optical fiber coil portion 103 is connected to one of the ends of the dispersion compensating fiber 105 in the adjacent optical fiber coil portion 103 through the single mode optical fiber 106. Furthermore, the single mode optical fiber 106 is led out of a front surface of the module housing 102 to the outside of the module housing 102.

As shown in FIG. 8, moreover, there has also been known a dispersion compensating fiber module in which dispersion compensators and light switches are provided in a module and the light switches are changed over to enable a wavelength dispersion quantity to be easily adjusted (for example, see JP-A-2001-160780). More specifically, a dispersion compensating fiber module 201 has a light switch SWₙ (1≦n≦4) and a dispersion compensator DCₙ (1≦n≦4) provided alternately, and furthermore, a light output portion 202 is provided between an input terminal 201a and an output terminal 201b. The light switch SWₙ serves to carry out switching into a second port P₂ or a third port P₃ and outputs a signal light input to a first port P₁. Moreover, the dispersion compensating module 201 comprises the dispersion compensator DCₙ having various dispersion compensating quantities determined depending on a state of optical path switching of the light switch SWₙ, and the dispersion compensating quantities are variable. More specifically, a signal light propagated through an optical transmission line 203 and reaching the input terminal 201a of the dispersion compensating fiber module 201 is compensated by the dispersion compensating quantity thus determined and is output from the output terminal 201b of the dispersion compensating fiber module 201.

When a dispersion compensating fiber module is disposed, a transmission distance from a station to each home or building is varied at each time. In a site in which an optical fiber is provided, accordingly, it is necessary to create the dispersion compensating fiber module for accommodating a dispersion compensating fiber with a length corresponding to the transmission distance.

When the transmission distance is defined and the dispersion compensating fiber module is made-to-order based on the transmission distance, however, a delivery date is prolonged. As described in the JP-A-2004-198821, when a plurality of dispersion compensating fiber modules is accommodated in a module, it is possible to accommodate variable dispersion compensating fibers 301 to 304 in an identical space 300 as shown in FIG. 9, for example. However, the excessively wasteful dispersion compensating fibers 303 and 304 are accommodated. For this reason, an extra cost is taken, and furthermore, a size of the whole module is also increased. Moreover, JP-A-2001-160780 has described a light switch which is expensive. In addition, there is also a method for properly adding each small-sized dispersion compensating fiber module 400 to obtain a desirable dispersion compensating quantity as shown in FIG. 10. However, a dispersion quantity is varied every place of a site and the number of the modules to be used every place is not known. For this reason, it is hard to maintain a space in some cases.

### DISCLOSURE OF THE INVENTION

In consideration of the circumstances, it is an object of the invention to provide an optical fiber module capable of adjusting and maintaining an optimum dispersion compensating quantity corresponding to a transmission distance to a place of provision on the scene even if the distance is variously changed and capable of being accommodated in a housing portion so as to be compact, a method for manufacturing an optical fiber module, and a closure.

The invention provides an optical fiber module comprises a fiber arranging portion including a plurality of fiber housing portions which are concentrically disposed and accommodate a dispersion compensating fiber, and a fiber connecting portion connecting the dispersion compensating fibers accommodated in any two of the fiber housing portions.

In the optical fiber module according to the invention, moreover, it is preferable that the fiber housing portion should be a housing disposed concentrically.

In the optical fiber module according to the invention, furthermore, it is preferable that the fiber housing portion comprises a fixing member for fixing a bundle of the dispersion compensating fibers.

The invention provides a method of manufacturing the optical fiber module described above, preparing a plurality of dispersion compensating fibers with different lengths, selecting the dispersion compensating fiber bundles to be accommodated based on a dispersion compensating fiber length which is calculated from a desirable fiber dispersion value, accommodating the selected dispersion compensating fiber bundles in the different fiber housing portions respectively, and connecting ends of the accommodated dispersion compensating fiber bundles to each other and accommodating a connecting portion in the fiber connecting portion.

In the manufacture of the optical fiber module according to the invention, it is preferable that an end core in the fiber of the dispersion compensating fiber bundle should be enlarged previously.

In the manufacture of the optical fiber module according to the invention, it is preferable that the dispersion compensating fiber which is strong for bending is selected and accommodated in an inner one of the fiber housing portions.

The invention provides a closure for accommodating a branch portion for branching and dropping a main cable into a drop cable, the closure having the optical fiber module described above.

According to the invention, it is possible to provide an optical fiber module capable of adjusting and maintaining an optimum dispersion compensating quantity corresponding to a transmission distance to a place of provision on the scene even if the distance is variously changed and capable of being accommodated in a housing portion so as to be compact, a method for manufacturing an optical fiber module, and a closure.

The other features and advantages are apparent from the description of an example and the attached claims.

### BRIEF DESCRIPTION OF THE DRAWINGS

FIG. 1(A) is a view showing a structure of a dispersion compensating fiber module according to a first embodiment of the invention,

FIG. 1(B) is a sectional view showing a housing and a dispersion compensating fiber,

FIG. 2 is an explanatory view showing a connecting state of a main part of the dispersion compensating fiber module in FIG. 1,

FIG. 3 is a view showing a structure of a dispersion compensating fiber module according to a second embodiment of the invention,

FIG. 4 is an explanatory view showing a connecting state of a main part of the dispersion compensating fiber module in FIG. 3,

FIG. 5 is a view showing a structure of a dispersion compensating fiber module according to a third embodiment of the invention,

FIG. 6 is an explanatory view showing a connecting state of a main part of the dispersion compensating fiber module illustrated in FIG. 5,

FIG. 7 is an explanatory view showing a structure of a conventional dispersion compensating fiber module,

FIG. 8 is an explanatory view showing a structure of another conventional dispersion compensating fiber module,

FIG. 9 is an explanatory view showing a defect of the conventional dispersion compensating fiber module, and

FIG. 10 is an explanatory view showing a defect of another conventional dispersion compensating fiber module.

### DETAILED DESCRIPTION OF EXAMPLE

A preferred embodiment according to the invention will be described below in detail with reference to the accompanying drawings.

### First Embodiment

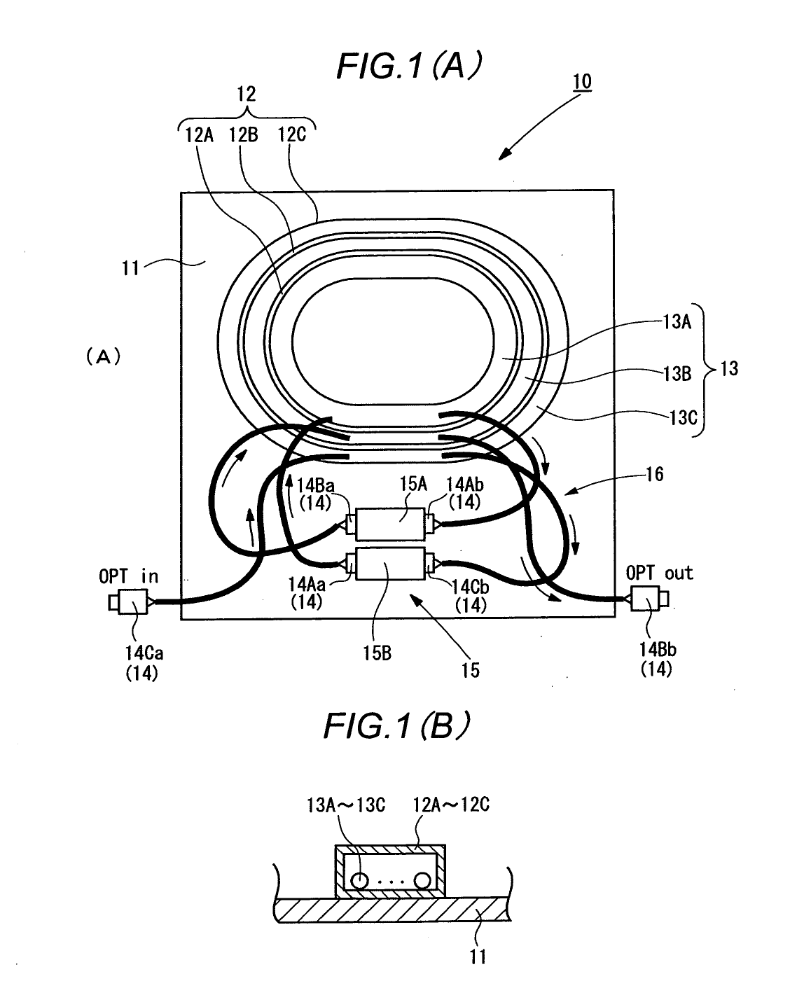

FIG. 1(A) shows a dispersion compensating fiber module (hereinafter referred to as a “DCFM”) 10 according to a first embodiment relating to an optical fiber module. In the DCFM 10, a closure 11 includes a fiber arranging portion 12 in which a plurality of fiber housing portions for accommodating a dispersion compensating fiber 13 is disposed concentrically, and connectors 14A to 14C and adaptors 15A and 15B which constitute a fiber connecting portion provided on both ends of each of the dispersion compensating fibers 13 in order to connect the dispersion compensating fibers 13 accommodated in each of the fiber housing portions.

The closure 11 accommodates a branch portion for branching and dropping a main cable into a drop cable, and protects the dispersion compensating fiber 13 accommodated therein from water or an external shock, which is not shown. Since the closure 11 takes a compact shape, it is disposed in an overhead portion to be connected in a branch from a main cable of a trunk transmission system into a drop cable. In the embodiment, the closure 11 takes a shape of an almost thin box which is formed to have a length of 220 mm, a width of 200 mm and a height of 20 mm respectively. The closure 11 can be opened and closed with a cover (coupled through a hinge) which is not shown.

The fiber housing portion is a housing (hereinafter referred to as housings 12A to 12C) which can be disposed concentrically and take an elliptical shape. The housings 12A to 12C are constituted by a pipe-shaped metal having a section taking a square shape as shown in FIG. 1(B), and are disposed concentrically with each other at regular intervals and are fixed to an internal surface of the closure 11. Moreover, DCFs 13A to 13C which will be described below are fixed to internal surfaces of the housings 12A to 12C in a bundle state by applying a proper adhesive such as a silicone resin to several positions.

The dispersion compensating fiber 13 is accommodated in the fiber housing portions 12A to 12C in bundles (dispersion compensating fiber bundles, hereinafter referred to as the DCFs 13A to 13C), respectively. In the embodiment, there is used the dispersion compensating fiber 13 having a feature of −300 ps/nm/km. That is, a transmission time is shortened (prolonged) by −300 ps as compared with a transmission light having a wavelength λ of 1.55 μm when a light having a longer (shorter) wavelength by 1 nm than the transmission light having the wavelength λ of 1.55 μm is propagated by 1 km. Moreover, the specific characteristic of the dispersion compensating fiber 13 is individually varied. In the embodiment, the dispersion compensating fiber 13 having characteristics shown in a to c of the following [Table 1] is used. The dispersion compensating fiber 13 coated with an ultraviolet cured resin having an outside diameter ψ of 0.2 mm is used to enhance an accommodating property. Moreover, any of the DCFs 13A to 13C which particularly has a great curvature (that is, has a small radius of curvature) and is provided on a central side (DCF 13A) has a strength which is resistant to bend in a curvature having a certain value.

TABLE 1

| | DCF to | Insertion | | Optical |
|---|---|---|---|---|
| Combination | be | loss | Dispersion | fiber |
| (type) | used | (1550 nm) | (1550 nm) | length |
| a | DCF13A | 1.2 dB | −100 ps/nm | 333 m |
| b | DCF13B | 1.3 dB | −101 ps/nm | 333 m |
| c | DCF13C | 1.1 dB | −100 ps/nm | 333 m |
| d | DCF13A + DCF13B | 2.5 dB | −201 ps/nm | 666 m |
| e | DCF13A + DCF13C | 2.3 dB | −200 ps/nm | 666 m |
| f | DCF13B + DCF13C | 2.4 dB | −201 ps/nm | 666 m |
| g | DCF13A + DCF13B + | 3.8 dB | −301 ps/nm | 999 m |
| | DCF13C | | | |

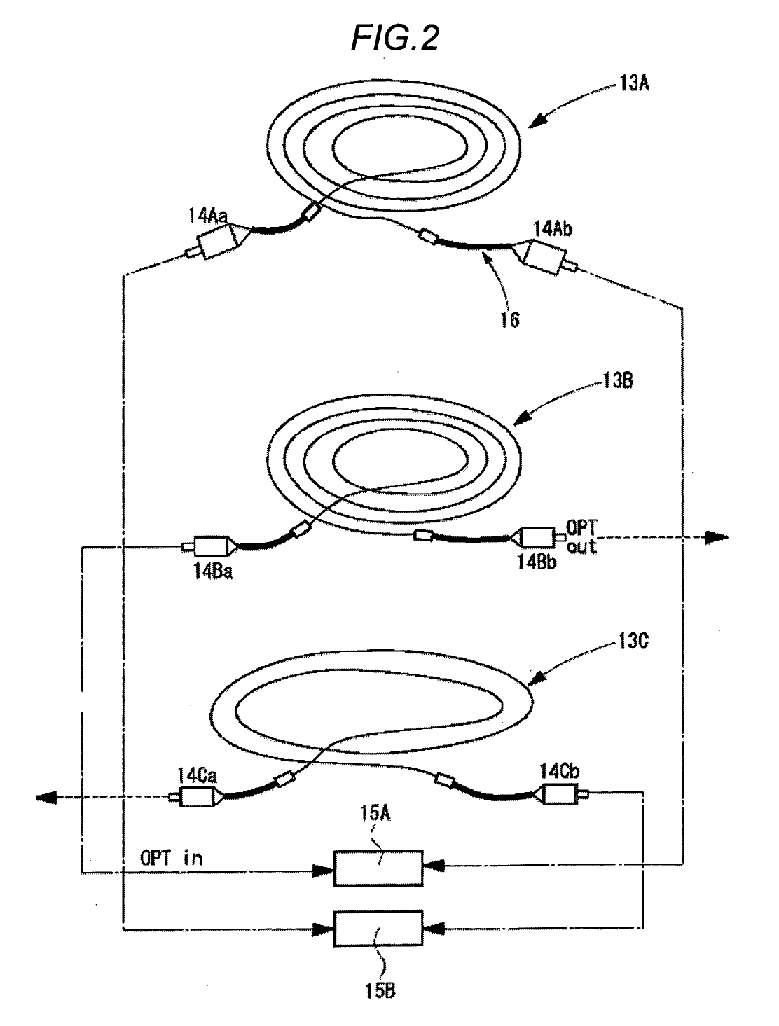

Moreover, the DCF 13A is fusion spliced to a 1.55 SMF coated with a polyamide resin having an outside diameter ψ of 0.9 mm in plural bundles in a smaller bundle diameter than the DCFs 13B and 13C, and the 1.55 SMF is accommodated in the housing 12A. As shown in FIG. 2, both end sides of the DCFs 13 which are obtained a 1.55 SMF pigtail 16 are pulled out from the housing 12A and connectors 14Aa and 14Ab. The connectors 14Aa and 14Ab are constituted by SC connectors. More specifically, an end of a pigtail (a pigtail having the SC connector) pulled out of the SC connector is fusion spliced to an end of the DCF. Referring to the DCF 13A, accordingly, the 1.55 SMF pigtail 16 is connected to an end (an inner end) pulled out of an innermost bundle and the 1.55 SMF pigtail 16 is connected to an end (an inner end) pulled out of an outermost bundle.

Similarly, the DCF 13B has a larger bundle diameter than the DCF 13A and has a smaller bundle diameter than the DCF 13C. The DCF 13B is accommodated in plural bundles in the housing 12B. In the same manner as the DCF 13A, moreover, the 1.55 SMF pigtail 16 is connected to an end (an inner end) of an innermost bundle of the DCF 13B pulled out of the housing 12B. The 1.55 SMF pigtail 16 is connected to an end (an inner end) of an outermost bundle thereof.

Furthermore, the DCF 13C has a larger winding diameter than the DCFs 13A and 13B and is accommodated in the housing 12C in plural bundles. In the same manner as the DCF 13A, moreover, the 1.55 SMF pigtail 16 is connected to an and (an inner end) of an innermost bundle of the DCF 13C pulled out of the housing 12C. The 1.55 SMF pigtail 16 is connected to an end (an inner end) of an outermost bundle thereof.

An SC adaptor is used for the adaptors 15A and 15B according to the embodiment, and two SC connectors used as the connectors 14A to 14C are coupled to obtain a connection therebetween. In the case, if one of the DCFs 13A to 13C is enough, it would not be necessary to use the adaptors 15A and 15B.

Next, description will be given to a method for manufacturing the DCFM according to the embodiment. First of all, there are prepared the dispersion compensating fiber (the dispersion compensating fiber bundle, DCFs 13A to 13C) 13 having different lengths, the 1.55 SMF pigtail 16, the adaptor 15 and the closure 11. Based on a dispersion compensating fiber length calculated from a desirable fiber dispersion value, a plurality of dispersion compensating fiber bundles (DCFs) to be accommodated in the closure 11 is selected. Next, the dispersion compensating fiber bundles thus selected, that is, the DCFs 13A to 13C are accommodated in the different housings 12A to 12C from each other in the closure 11. More specifically, portions other than both ends of each of the DCFs 13 are accommodated in the housings 12A to 12C disposed concentrically. Moreover, each of the ends of the DCFs 13A to 13C exposed to the outside in a pull-out state from the housings 12A to 12C is fusion spliced to the 1.55 SMF pigtail 16 with the connectors (14A to 14C).

When the DCFM 10 is actually used on the scene, ends of any of the DCFs 13A to 13C selected corresponding to a dispersion compensating quantity on the scene are connected to each other by the connectors 14A to 14C through the adaptors 15A and 15B. The connector 14 in the connecting portion is accommodated in the closure 11. It is preferable that the DCF having great bending which is resistant to a bending strength in a curvature having a predetermined value should be selected and accommodated in the housing 12A on an innermost side. Thus, a transmission loss caused by the bending can be reduced as greatly as possible.

In the DCFM 10 according to the embodiment, any of the DCFs 13A to 13C is not only used singly (in the Table 1, a to c) but at least two of them are combined (in the Table 1, d to g) so that a necessary dispersion compensating quantity can be met. In other words, some of the connectors 14A to 14C are selected and coupled through at least one of the adaptors 15A and 15B. Two or three DCF bundles are connected into one so that the necessary dispersion compensating quantity can be maintained. When at least one of the adaptors 15A and 15B is used, thus, one of the connectors which is not coupled to the adaptors 15A and 15B is connected to a drop cable branched from the trunk transmission system (the main cable) (which is represented as OPTin). The other is connected to an optical outside wire on a home or building side (which is represented as OPTout).

For example, when the SMF is provided at a distance of 5.8 km from a station side to a subscriber side, a dispersion compensating quantity of approximately −100 ps/nm is required correspondingly. Therefore, it is sufficient that one of a to c in the Table 1, that is, one of the DCFs 13A to 13C is used singly. In this case, any of the connectors 14A to 14C provided on both ends is set into OPTin and OPTout.

When the necessary dispersion compensating quantity is approximately −200 ps/nm, for example, two of d to f in the Table 1, that is, two of the DCFs 13A to 13C are coupled into one through the adaptor 15A or 15B. Any of the connectors 14A to 14C provided on both ends thereof is set into OPTin and OPTout.

As shown in the type of g in the Table 1, that is, a connecting state illustrated in a chain line of FIG. 2, When the necessary dispersion compensating quantity is approximately −300 ps/nm, for example, it is preferable that all of the DCFs 13A to 13C should be connected into one through the connectors 14A to 14C and the adaptors 15A and 15B. One of the two connectors 14 which are not connected to any of both ends of each of the DCFs 13A to 13C connected into one should be set into OPTin. The other should be set into OPTout.

According to the embodiment, therefore, it is possible to easily carry out the dispersion compensating work on the scene without executing a complicated fusion splicing work on the scene by properly using the DCFs 13A to 13C and the connectors 14A to 14C in the closure 11 provided on an overhead connected in a branch from a main cable of a trunk transmission system into a drop cable. Because, a plurality of dispersion compensating fibers with different lengths is prepared in advance, it is possible to cope with various lengths depending on a combination and to create a dispersion compensating fiber module corresponding to a necessary dispersion compensating quantity. In addition, since the fiber housing portion is the housings 12A to 12C which can be disposed concentrically, it can be accommodated in the closure 11 to be compact.

### Second Embodiment

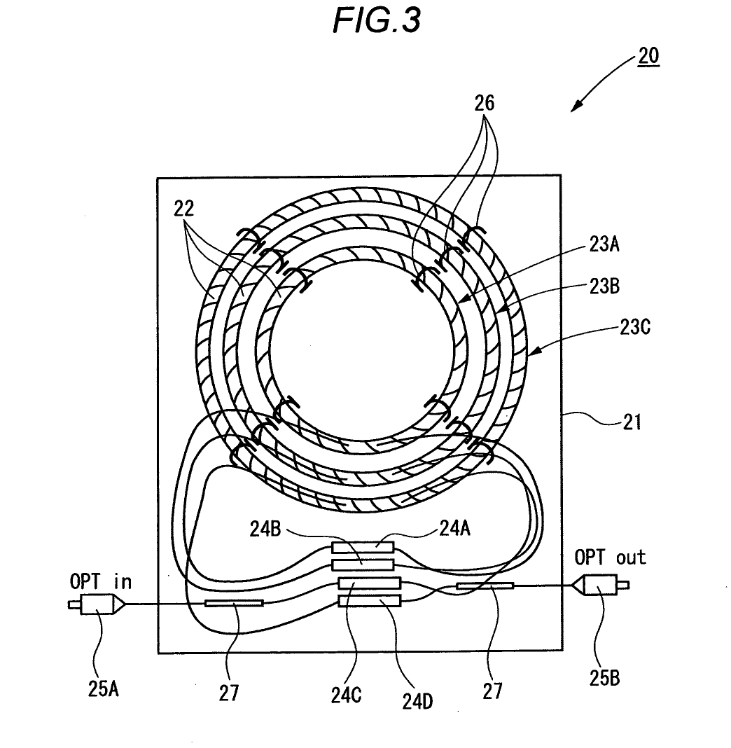

Next, description will be given to a DCFM according to a second embodiment of the invention. FIG. 3 shows a dispersion compensating fiber module (DCFM) 20 according to the second embodiment of the invention. In the DCFM 20, a closure 21 includes DCFs 23A to 23C fixed through a hook 26 to be a fixing member, mechanical splices 24A to 24D for connecting both ends of each of the DCFs 23A to 23C, and a connector 25A for OPTin and a connector 25B for OPTout which are attached to two of the mechanical splices 24A to 24D.

The DCFs 23A to 23C have the same structures as those in the first embodiment and have a characteristic of −300 ps/nm/km. Moreover, the DCFs 23A to 23C have different bundle diameters from each other, which are formed to be large, middle and small in a completely round shape and are concentrically disposed. A spiral tube 22 is wound around each of outer peripheral surfaces of the DCFs 23A to 23C. The specific characteristics of the DCFs 23A to 23C are shown in h to j of the following [Table 2].

TABLE 2

| | DCF to | Insertion | | Optical |
|---|---|---|---|---|
| Combination | be | loss | Dispersion | fiber |
| (type) | used | (1550 nm) | (1550 nm) | length |
| h | DCF23A | 2.0 dB | −168 ps/nm | 560 m |
| i | DCF23B | 1.9 dB | −171 ps/nm | 560 m |
| j | DCF23C | 2.2 dB | −173 ps/nm | 560 m |
| k | DCF23A + DCF23B | 2.9 dB | −339 ps/nm | 1120 m |
| l | DCF23A + DCF23C | 4.2 dB | −341 ps/nm | 1120 m |
| m | DCF23B + DCF23C | 4.1 dB | −344 ps/nm | 1120 m |
| n | DCF23A + DCF23B + | 3.9 dB | −512 ps/nm | 1680 m |
| | DCF23C | | | |

The DCFs 23A to 23C are held through fixing hooks 26A to 26C provided in four places in the closure 21 respectively and are bundled. Outside diameters are gradually increased in order of the DCF 23A, the DCF 23B and the DCF 23C.

Moreover, the DCFs 23A to 23C are subjected to a TEC (Thermal Expand Core) processing. Both ends of the core diameters are increased by TEC to be easily be connected through the mechanical splices 24A to 24D which will be described below respectively. In the TEC processing, an MFD (Mode Field Diameter) on each end side is constituted to be equal to or larger than 6 μm.

Each of the mechanical splices 24A to 24D includes a substrate having a V groove provided on an upper surface, a cover member mounted on an upper surface of the substrate and fixed integrally therewith in order to set optical fibers making a pair to be connected into the V groove with end faces thereof matched with each other and to press and fix the end faces from above, and a leaf spring for fixing the substrate and the cover member integrally, which are not shown. An end of an optical fiber fusion spliced through a fusing portion 27 to a pigtail having connectors for in/out attached to either side of the V groove is previously loaded onto the mechanical splices 24C and 24D.

First of all, an optimum one of the three types of DCFs 23A to 23C is selected corresponding to a necessary dispersion compensating quantity. For example, in case of −170 ps/nm, one of them is enough. Accordingly, when the DCF 23A is used, for example, coats of both ends 23Aa and 23Ab are peeled by using a proper tool to take glass part of optical fiber out. Then, a necessary processing is carried out. The end 23Aa of the DCF 23A is thereafter set and fixed to a right side of a V groove of the mechanical splice 24C to which one of ends of a dispersion compensating fiber core fusion spliced to a 1.55 SMF pigtail having the connector 25A for OPTin attached thereto is set. Similarly, the end 23Ab on an opposite side in the DCF 23A is set and fixed to a left side of the V groove of the mechanical splice 24D to which one of ends of a dispersion compensating fiber core fusion spliced to a 1.55 SMF pigtail having the connector 25B for OPTout attached thereto is set. When also the DCF 23B or the DCF 23C is used, it is preferable that the same work should be carried out.

Thereafter, there are carried out a connection to a branch portion (a drop cable) from a trunk transmission system (a main cable) through the connector 25A (OPTin is set) and a connection of the other to an optical outside wire on a home or building side through the connector 25B (OPTout is set). Consequently, it is possible to maintain a dispersion compensating quantity required between a station side and a subscriber side.

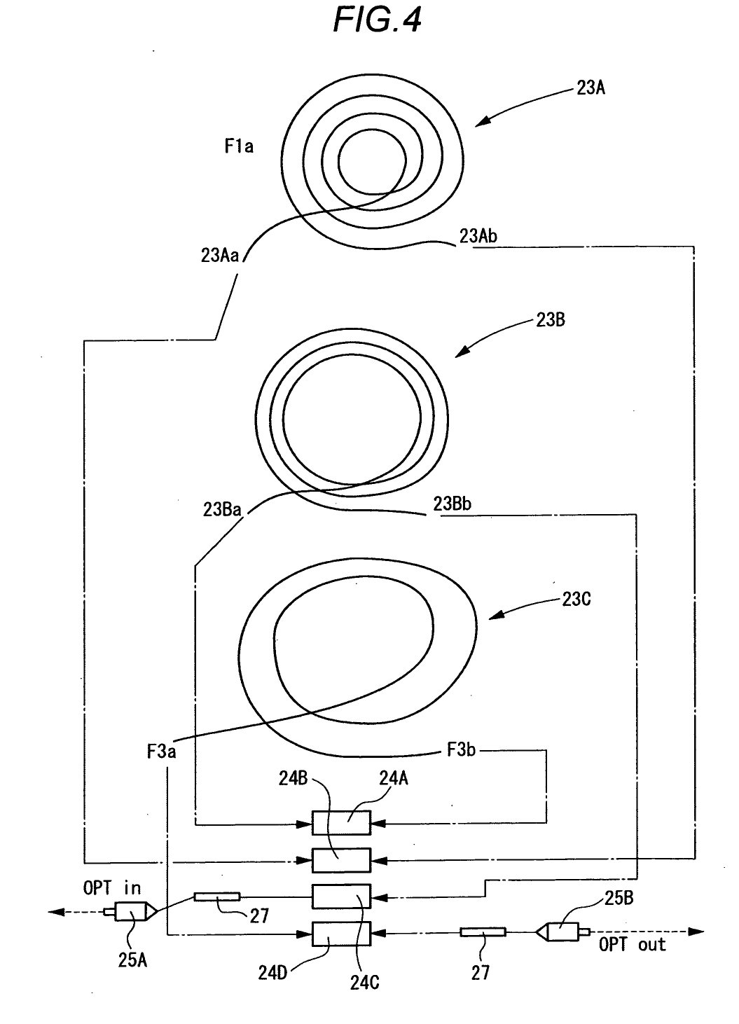

When the necessary dispersion compensating quantity is −340 ps/nm, for example, it is preferable that two of the three types of DCFs 23A to 23C should be coupled into one for use. Further, when a combination of an m type (so are k and l types) in the Table 2 is applied, for example, coats of both ends of each of the DCFs 23B and 23C are peeled to take glass part of optical fiber out in the same manner as in case of the single use in FIG. 4. After a necessary processing is then carried out, an end 23Ba of the DCF 23B is set to a left side of a V groove of the mechanical splice 24A (which is not shown). An end 23Bb of the DCF 23C is set and fixed to a right side of the V groove of the mechanical splice 24A (which is not shown), and they are thus fixed, for example. Next, the end 23Bb of the DCF 23B is set and fixed to a right side of a V groove of the mechanical splice 24C and is thus connected to the connector 25A for OPTin, for example. Moreover, the end 23Ba of the DCF 23C is set and fixed to a left side of a V groove of the mechanical splice 24D and is thus connected to the connector 25B for OPTout. Thereafter, a connection is carried out in the same manner as in case of the single use. Consequently, it is possible to maintain a dispersion compensating quantity required between the station side and the subscriber side.

When the necessary dispersion compensating quantity is −510 ps/nm, for example, it is preferable to couple all of the three types of DCFs 23A to 23C into one for use (see n in the [Table 2]). A specific connection in that case is shown in a one-dotted chain line of FIG. 4.

According to the second embodiment, therefore, it is possible to carry out a connection between the DCFs with a simple structure and a low loss. In addition, an end of each of the DCFs does not need to be permanently connected. Therefore, it is possible to carry out a recombination, thereby changing a dispersion compensating quantity or performing a readjustment if necessary. Also in the second embodiment, moreover, the closure 21 to be a housing space is sufficiently small and can be disposed on an overhead. By freely using the DCFs 23A to 23C and the mechanical splices 24A to 24D in the closure 21 disposed on the overhead of a drop cable connected in a branch from a main cable of a trunk transmission system, therefore, it is possible to easily carry out a dispersion compensating work in that place. In addition, the DCFs are connected through a mechanical splice so that the number of connecting components can be reduced more greatly than that in the first embodiment. Correspondingly, an insertion loss can be decreased and a connecting man-hour can be reduced.

### Third Embodiment

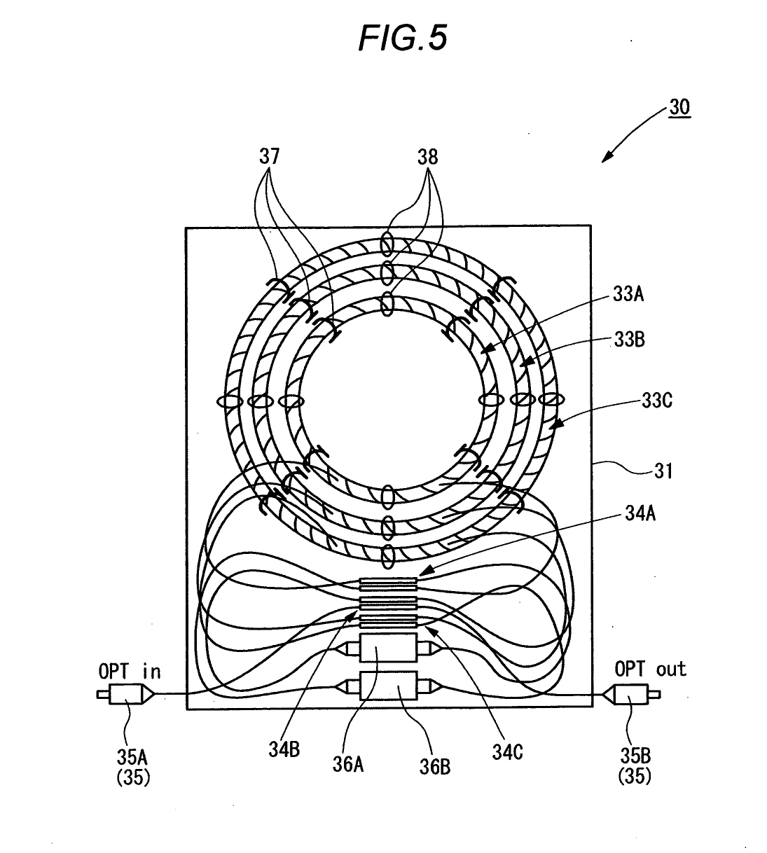

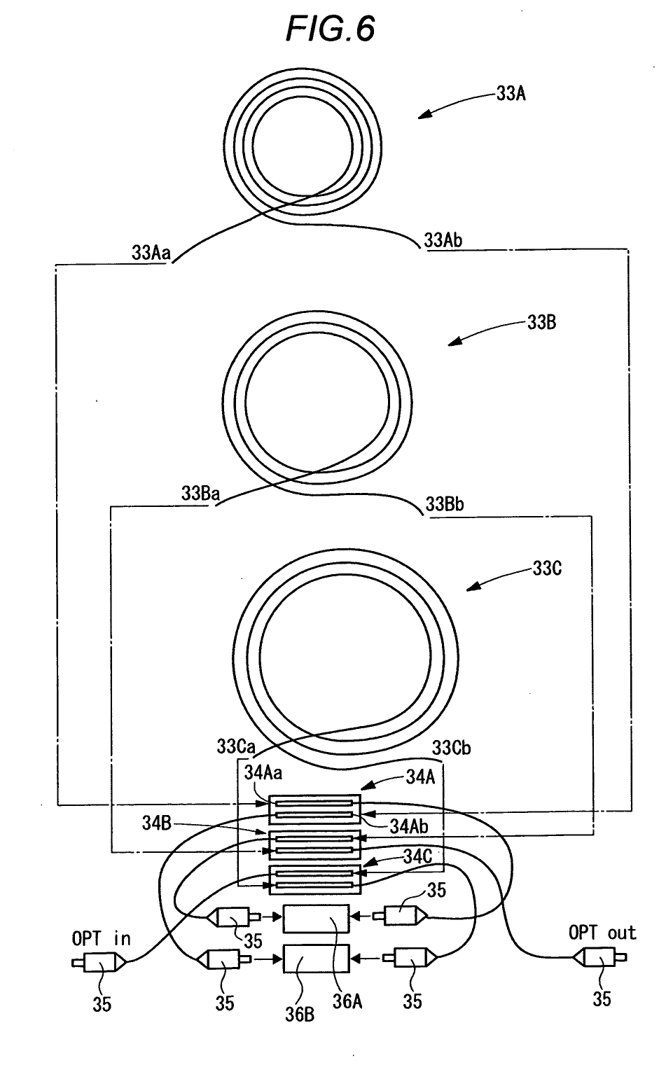

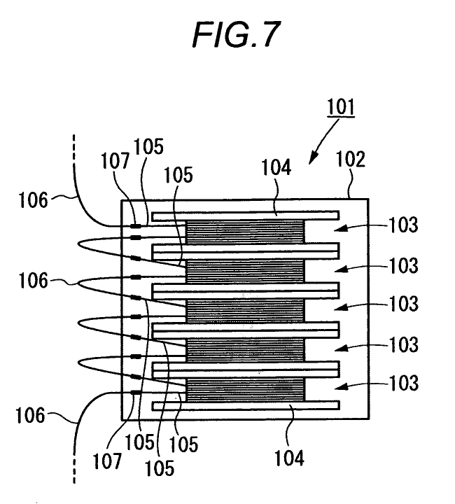

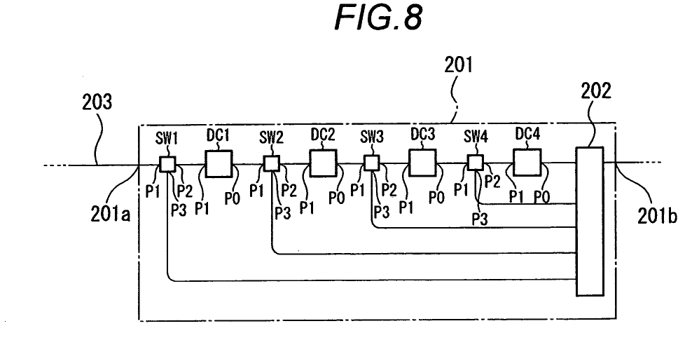

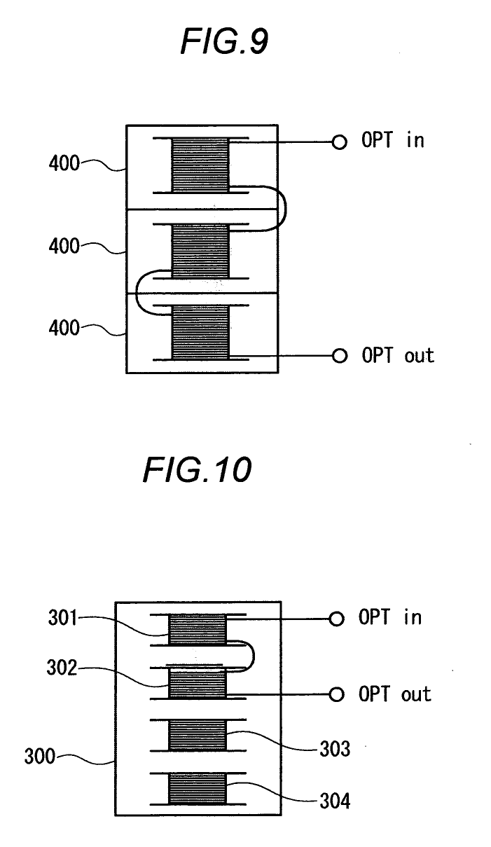

Next, description will be given to a DCFM according to a third embodiment of the invention. FIG. 5 shows a dispersion compensating fiber module (DCFM) 30 according to the third embodiment of the invention. In the DCFM 30, a closure 31 includes DCFs 33A to 33C which are disposed to be concentrically small, middle and large in a bundle in a completely round shape and are fixed through a hook 37 to be a fixing member, fusing portions 34A to 34C for connecting both ends of each of the DCFs 33A to 33C, connectors 35 fused to the fusing portions 34A to 34C and serving as connectors for OPTin and OPTout respectively, and adaptors 36A and 36B.

The DCFs 33A to 33C are coated with a polyamide resin having an outside diameter ψ of 0.9 mm in such a manner that a worker can handle them on the scene, and a −300 ps/nm/km dispersion compensating fiber is used for all of them. Moreover, the DCFs 33A to 33C are fusion spliced to a pigtail having an SC connector through the fusing portions 34A to 34C. Furthermore, the DCFs 33A to 33C are fixed to an internal surface of the closure 31 in a bundle state through an application of a proper adhesive 38 such as a silicone resin to several portions, respectively. Specific characteristics of the DCFs 33A to 33C according to the third embodiment are shown in o to q in the following [Table 3]. The DCFs 33A to 33C are also fixed through an application of a proper adhesive such as a silicone resin to several portions in a bundle state on an internal surface of the closure 31 in the same manner as in the first embodiment respectively.

TABLE 3

| | DCF to | Insertion | | Optical |
|---|---|---|---|---|
| Combination | be | loss | Dispersion | fiber |
| (type) | used | (1550 nm) | (1550 nm) | length |
| o | DCF33A | 0.8 dB | −8 ps/nm | 27 m |
| p | DCF33B | 0.7 dB | −8 ps/nm | 27 m |
| q | DCF33C | 0.8 dB | −8 ps/nm | 27 m |
| r | DCF33A + DCF33B | 1.5 dB | −16 ps/nm | 54 m |
| s | DCF33A + DCF33C | 1.6 dB | −16 ps/nm | 54 m |
| t | DCF33B + DCF33C | 1.5 dB | −16 ps/nm | 54 m |
| u | DCF33A + DCF33B + | 2.3 dB | −24 ps/nm | 81 m |
| | DCF33C | | | |

One of ends on an opposite side to the other end of a pigtail (an optical fiber) to which each of the connectors 35 is connected is fused to the fusing portion 34. On the other hand, the same SC adaptor as that in the first embodiment is used for the adaptors 36A and 36B and an SC connector which is selected can easily be coupled by a push-pull method.

For example, an optional DCF in a bundle state is loosened on the scene and a winding work is carried out in such a manner that the DCF can be accommodated in a necessary quantity in a DCFM installation tray so as to have a desirable accommodation diameter. Next, both ends of the DCF with a desirable length are fused through any of the fusing portions 34A to 34C and are thus connected to the connector. For example, the coat is peeled from both ends of the DCF 33A to take glass part of optical fiber core out. Then, respective ends (33Aa, 33Ab) of the DCF 33A are fusion spliced to partner side portions to be connected to the pigtail (the other end of the optical fiber) of the fusing portion 34A, that is, fusing portions 34Aa and 34Ab. Consequently, the DCF 33A having the connector 35 attached thereto is formed. When lengths of the DCFs 33B and 33C are adjusted if necessary and the connector 35 is then attached in the same manner moreover, it is possible to maintain a dispersion compensating quantity of −24 ps/nm at a maximum by coupling the respective DCFs 33 into one through the connector 35 and the adaptors 36A and 36B.

Also in the third embodiment, accordingly, the closure 31 for accommodating the DCFs 33A to 33C therein is sufficiently small and can be disposed on an overhead. Therefore, it is possible to easily carry out the dispersion compensating work in that place by properly using the DCFs 33A to 33C and the adaptors 36A and 36B which are disposed in the closure 31 provided on the overhead connected in a branch from the main cable in the trunk transmission system into the drop cable. In addition, the DCFs 33A to 33C are cut to form ends corresponding to the dispersion compensating quantity which is required on the scene. Thus, the length of the DCF in each bundle can be changed freely. Consequently, it is not necessary to individually prepare DCFs with different lengths for bundles having different winding diameters as in the first and second embodiments.

The invention is not restricted to these embodiments but can be carried out in various modes without departing from the scope thereof.

What is claimed is:

1. An optical fiber module comprising:
a fiber arranging portion including a plurality of fiber housing portions which are concentrically disposed and accommodate a dispersion compensating fiber, and
a fiber connecting portion connecting the dispersion compensating fibers accommodated in any two of the fiber housing portions.

2. The optical fiber module according to claim 1,
wherein the fiber housing portion is a housing disposed concentrically.

3. The optical fiber module according to claim 1,
wherein the fiber housing portion comprises a fixing member for fixing a bundle of the dispersion compensating fibers.

4. A method of manufacturing the optical fiber module according to claim 1, comprising:
preparing a plurality of dispersion compensating fibers with different lengths;
selecting the dispersion compensating fiber bundles to be accommodated based on a dispersion compensating fiber length which is calculated from a desirable fiber dispersion value;
accommodating the selected dispersion compensating fiber bundles in the different fiber housing portions respectively, and
connecting ends of the accommodated dispersion compensating fiber bundles to each other and accommodating a connecting portion in the fiber connecting portion.

5. The method of manufacturing the optical fiber module according to claim 4,
wherein an end core in the fiber of the dispersion compensating fiber bundle is enlarged previously.

6. The method of manufacturing the optical fiber module according to claim 4,
wherein the dispersion compensating fiber which is strong for bending is selected and accommodated in an inner one of the fiber housing portions.

7. A closure for accommodating a branch portion for branching and dropping a main cable into a drop cable, comprising:
the closure having the optical fiber module according to claim 1.
